(19) United States
(12) Patent Application Publication
(10) Pub. No.: US 2010/0017045 A1
(43) Pub. Date: Jan. 21, 2010

(54) ELECTRICAL DEMAND RESPONSE USING ENERGY STORAGE IN VEHICLES AND BUILDINGS

(75) Inventors: Clay G. Nesler, Brookfield, WI (US); Michael G. Andrew, Menomonee Falls, WI (US); John I. Ruiz, New Berlin, WI (US); David B. Busch, Fishers, IN (US)

Correspondence Address: Johnson Controls, Inc.;c/o Fletcher Yoder PC, P.O. Box 692289, Houston, TX, 77269, US

(73) Assignee: Johnson Controls Technology Company, Holland, MI (US)

(21) Appl. No.: 12/324,687

(22) Filed: Nov. 26, 2008

Related U.S. Application Data
(60) Provisional application No. 60/991,583, filed on Nov. 30, 2007.
(60) Provisional application No. 61/103,557, filed on Oct. 7, 2008.
(60) Provisional application No. 61/103,561, filed on Oct. 7, 2008.
(60) Provisional application No. 61/103,563, filed on Oct. 7, 2008.

(51) Int. Cl. G06F 1/30; G06F 1/28

(52) U.S. Cl. 700/296; 700/295

(57) ABSTRACT

The present invention relates to a system having a building control system with a vehicle battery controller. The vehicle battery controller may be configured to control a vehicle battery charge and a vehicle battery discharge of a vehicle having a vehicle battery coupled to an electrical system of a building.

### CROSS REFERENCE TO RELATED APPLICATIONS

This application claims priority from and the benefit of U.S. Provisional Application Ser. No. 60/991,583, entitled “ELECTRICAL DEMAND RESPONSE SYSTEM”, filed Nov. 30, 2007, which is hereby incorporated by reference in its entirety, U.S. Provisional Application Ser. No. 61/103,557, entitled “EFFICIENT USAGE, STORAGE, AND SHARING OF ENERGY IN BUILDINGS, VEHICLES, AND EQUIPMENT”, filed Oct. 7, 2008, which is hereby incorporated by reference in its entirety, U.S. Provisional Application Ser. No. 61/103,561, entitled “EFFICIENT USAGE, STORAGE, AND SHARING OF ENERGY BETWEEN VEHICLES AND BUILDINGS”, filed Oct. 7, 2008, which is hereby incorporated by reference in its entirety, and U.S. Provisional Application Ser. No. 61/103,563, entitled “EFFICIENT USAGE, STORAGE, AND SHARING OF ENERGY BETWEEN VEHICLES AND THE ELECTRIC POWER GRID”, filed Oct. 7, 2008, which is hereby incorporated by reference in its entirety.

### BACKGROUND

The invention relates generally to electrical demand response using energy storage in vehicles and buildings.

Energy drives a myriad of devices and equipment in commercial, industrial, and residential applications. For example, energy drives lights, motors, household appliances, medical equipment, computers, heating and air conditioning systems, and many other electrical devices. Some of these devices require continuous power to function, e.g., medical monitoring equipment. Unfortunately, the existing infrastructure relies heavily on fossil fuels to power combustion engines in vehicles and equipment, and power utilities to generate and distribute electricity through a power grid to the various applications.

Shortages and/or increased costs associated with fossil fuels and electricity from power utilities significantly impact consumers and businesses. In general, shortages and/or increased costs often occur during times of peak demand. On a daily basis, peak demand occurs during the daytime, while minimum demand occurs during the night time. On a more random basis, peak demand (or a demand greater than an available supply) may occur as a result of a natural disaster. For example, a hurricane or earthquake may damage the power grid and/or electric generators of the power utilities, thereby resulting in substantial loss of electric power to commercial, industrial, and residential applications. Repairs to these damaged lines and generators may take hours, days, or weeks. Various sites also may lose power from the power grid for other reasons. During these times of lost power, the sites may be unable to continue operations.

Often, energy is more expensive during times of peak demand. For example, a power utility may employ low cost electrical generators during periods of minimum demand, while further employing high cost electrical generators during periods of peak demand. Unfortunately, the existing infrastructure does not adequately address these different costs associated with peak and minimum demands. As a result, commercial, industrial, and residential applications typically draw power from the power grid during times of peak demand, e.g., daytime, despite the higher costs associated with its generation.

### SUMMARY

The present invention relates to a system having a building control system with a vehicle battery controller. The vehicle battery controller may be configured to control a vehicle battery charge and a vehicle battery discharge of a vehicle having a vehicle battery coupled to an electrical system of a building.

The present invention also relates to a system having a building control system with an energy controller. The energy controller may be configured to vary usage of grid power from a power utility and battery power from a battery in response to real time pricing of grid power.

The present invention also relates to a system having a control panel with a demand response controller and a vehicle battery controller. The demand response controller may be configured to receive a demand response control signal from a power utility. The vehicle battery controller may be configured to control a vehicle battery charge and a vehicle battery discharge of a vehicle having a vehicle battery based on the demand response control signal from the power utility.

### DRAWINGS

FIG. 1A is a schematic of an exemplary embodiment of an electrical demand response system having a utility energy management system, a home energy management system, a vehicle control system, and a building management system.

FIG. 1B is a block diagram of an exemplary embodiment of a vehicle coupled to a residential building, showing vehicle having vehicle control system coupled to a battery, and residential building having home energy management system coupled to a vehicle charging station and a stationary battery.

FIG. 1C is a schematic of an exemplary embodiment of vehicle coupled to vehicle charging station at a commercial building.

FIG. 2A is a schematic of an exemplary embodiment of a residential building having the home energy management system of FIG. 1, showing an electrical demand response during a period of peak demand (e.g., mid-day) on a power grid.

FIG. 2B is a block diagram of an exemplary embodiment of residential building having both vehicle to building (V2B) and battery to building (B2B) electricity transfers.

FIG. 2C is a block diagram of an exemplary embodiment of residential building having vehicle to building (V2B) and battery to building (B2B) electricity transfers, and a building to grid (B2B) electricity transfer.

FIG. 3A is a schematic of an exemplary embodiment of a residential building having the home energy management system of FIG. 1, showing an electrical demand response during a period of off-peak demand (e.g., midnight) on a power grid.

FIG. 3B is a block diagram of an exemplary embodiment of residential building having both power grid to vehicle (G2V) and power grid to battery (G2B) electricity transfers for charging vehicle and stationary batteries.

FIG. 4A is a schematic of an exemplary embodiment of a residential building having the home energy management system of FIG. 1, showing an electrical demand response during a period of power outage (e.g., storm or natural disaster) from a power grid.

FIG. 4B is a block diagram of an exemplary embodiment of residential building having both vehicle to building (V2B) and battery to building (B2B) electricity transfers during a power interruption from a power grid.

FIG. 5 is a schematic of an exemplary embodiment of a user interface for the home energy management system of FIGS. 1 through 4.

FIG. 6 is a block diagram of an exemplary embodiment of a residential electrical demand response system having the home energy management system of FIGS. 1 through 5.

FIG. 7 is a block diagram of an exemplary embodiment of the home energy management system of FIGS. 1 through 6.

FIG. 8 is a block diagram of an exemplary embodiment of a commercial electrical demand response system having the building management system of FIG. 1.

FIG. 9 is a block diagram of an exemplary embodiment of the building management system of FIGS. 1 and 8.

### DETAILED DESCRIPTION

In certain exemplary embodiments, a variety of alternative energy sources and energy storage systems may be used to improve electrical reliability, reduce non-sustainable energy consumption, and reduce the peak demand on electric utilities. The energy sources and storage systems may be used to share energy between buildings, vehicles, equipment, and the power grid. The energy sharing may occur in real-time or time-delayed based on various factors, such as energy costs, energy demand, and user comfort. One type of energy storage is a battery or set of batteries, such as stationary or mobile batteries. For example, stationary batteries may be installed on-site of a building or home. Vehicle batteries may be disposed in an electric vehicle (EV), hybrid electric vehicle (HEV), plug-in hybrid electric vehicle (PHEV), or a combustion engine vehicle. In exemplary embodiments, the batteries may enable energy sharing from battery to building (B2B) or vice versa, battery or building to grid (B2G) or vice versa, vehicle to building (V2B) or vice versa, vehicle to grid (V2G) or vice versa, or another energy sharing arrangement. V2G may include V2B (vehicle to building) plus B2G (building to grid). The batteries may be connected to the power grid coming into a building, but could be an entirely separate power system for a building. Other energy sources may include wind power (e.g., wind turbines), solar power (e.g., solar photovoltaic panels), momentum power (e.g. flywheels), thermal power (e.g. ice storage), and hydroelectric power (hydroelectric turbines). However, any other energy source may be employed along with the exemplary embodiments.

In exemplary embodiments, a building or vehicle control system may integrate energy control features to optimize usage of energy sources and distribution of energy among various loads based on energy demand, real time pricing (RTP) of energy, and prioritization of loads. For example, the building or vehicle control system may include a control panel having a building control, a vehicle control, a grid power control, a battery power control, a solar power control, a wind power control, an electricity buying/selling control, a battery charging/discharging control based on real time pricing (RTP) of energy, and a carbon counter. The control panel may be integrated into a residential building, a commercial building, or a vehicle (e.g., a PHEV).

In exemplary embodiments, an electrical demand response system and methodology may provide stored electrical energy from a vehicle (e.g., PHEV) back to the electrical grid or directly to building electrical distribution systems during periods of peak utility demand. The PHEV may be charged during off-peak hours by a plug-in connection with a building or through the use of the internal combustion engine. The electrical demand response system and method can be integrated into any power grid, vehicle, or building.

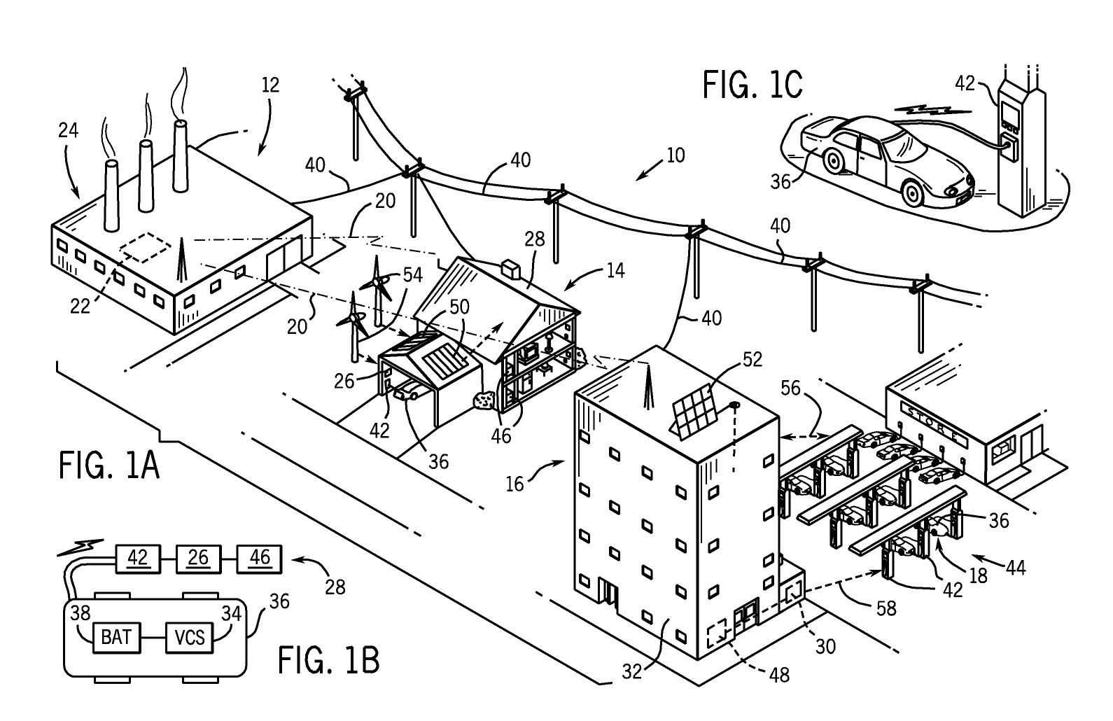

FIG. 1A is a schematic of an exemplary embodiment of an energy management or electrical demand response system 10 having vehicle energy storage in residential, commercial, and industrial locations. In an exemplary embodiment, the electrical demand response system 10 may include a utility demand response system 12, a residential demand response system 14, a commercial demand response system 16, and a vehicle demand response system 18. Each of these systems 12, 14, 16, and 18 may include an energy management system configured to control various aspects of the vehicle energy storage, such as charging and discharging of the vehicle energy storage in response to demand response signals 20. In an exemplary embodiment, utility demand response system 12 includes a utility energy management system (UEMS) 22 at a power utility 24, residential demand response system 14 includes a home energy management system (HEMS) 26 at a residential building 28, commercial demand response system 16 includes a building management system (BMS) 30 at a commercial building 32, and vehicle demand response system 18 includes a vehicle control system (VCS) 34 in a vehicle 36 (FIG. 1B).

Vehicles 36 may include two or more power sources, such as battery power from battery 38 and power from a second source such as an internal combustion engine or a fuel cell. Both power sources are controlled by a vehicle power management system or VCS 34. In an exemplary embodiment, each vehicle 36 may be a PHEV or EV. A PHEV maintains all the functional performance features of a regular hybrid, but differs significantly in two key aspects: 1) the battery capacity is significantly greater in order to provide substantial electric-only operating range; and 2) the vehicle can be plugged into conventional AC power outlets to recharge the battery. For a hybrid, you may fill it up at the gas station, and you may plug it in to an electrical outlet such as a typical 120-volt outlet. Vehicles 36 may include automobiles, motorcycles, buses, recreational vehicles, boats, and other vehicle types. The battery 38 is configured to provide at least a portion of the power to operate the vehicle 36 and/or various vehicle systems. Battery 38 may include several cells in either modular form or as a stand-alone multi-cell array. Battery 38 can be made of modules or individual cells. Battery 38, such as a complete plug'n play battery, may include a box, wires, cells, and modules. For example, battery 38 may include a group of cells configured into a self-contained mechanical and electrical unit. Vehicle 38 may include one, two, three, four, or more of these self-contained plug'n play units. Each cell includes one or more positive electrodes, one or more negative electrodes, separators between the electrodes, and other features to provide an operational battery or cell within a housing or tray. Battery 38 may include other components (e.g., a battery management system (BMS) that are electrically coupled to the cells and may be adapted to communicate directly or through a battery management system to VCS 34. Vehicles 36 may be configured to be plugged in at home at night for charging. Overnight electrical power may be available at a lower cost than power used during peak hours of the day.

Each vehicle 36 includes one or more energy storage devices, such as battery packs 38 (FIG. 1B), which are accessible and controllable by electrical demand response system 10. For example, UEMS 22, HEMS 26, BMS 30, and VCS 34 may control the charging and discharging of the battery packs 38 based on demand response signals 20. Battery packs 38 may receive electrical power from power utility 24 through an electric power grid 40 and charging stations 42 (FIGS. 1A, 1B, and 1C) disposed at residential building 28, commercial building 32, a parking lot 44, or another location. In an exemplary embodiment, battery packs 38 in each vehicle 36 may provide power back to residential building 28, commercial building 32, and electric power grid 40 based on demand response signals 20. UEMS 22, HEMS 26, BMS 30, and VCS 34 are configured to control the charging and discharging of battery packs 38 located within plugged-in vehicles 36 to respond to variations in energy demand, real time pricing (RTP) of energy, power outages, and other factors.

In an exemplary embodiment, UEMS 22 of power utility 24 is configured to supplement electrical power generation capabilities with a variety of renewable distributed energy sources, including battery packs 38 in various vehicles 36, stationary batteries 46 in residential buildings 28, stationary batteries 48 in commercial buildings 32, solar panels 50 at residential buildings 28, solar panels 52 at commercial buildings 32, and wind turbines 54 at residential and commercial buildings 28 and 32. UEMS 22 of power utility 24 also may utilize stationary batteries, solar panels, and wind turbines at other distributed locations, such as wind farms, solar energy farms, and battery storage facilities. In an exemplary embodiment, UEMS 22 may transmit demand response signals 20 to obtain additional energy from these distributed energy sources during periods of high demand, and may transmit demand response signals 20 to cease using some or all of these distributed energy sources during periods of low energy demand.

Peak energy demand may occur during the daytime around midday, whereas minimum energy demand may occur during the nighttime around midnight. In an exemplary embodiment, UEMS 22 may transmit demand response signals 20 to discharge distributed batteries 38, 46, and 48 into electric power grid 40 to supplement the power generation capabilities of power utility 24 during periods of peak demand. During periods of minimum energy demand, UEMS 22 may transmit demand response signals 20 to charge distributed batteries 38, 46, and 48. In an exemplary embodiment, UEMS 22 may be given complete control of the charging and discharging of distributed batteries 38, 46, and 48. However, in certain embodiments of electrical demand response system 10, the charging and discharging of batteries 38, 46, and 48 may be at least partially or entirely controlled by HEMS 26, BMS 30, and/or VCS 34.

Referring generally to FIGS. 1A and 1B, an exemplary embodiment of HEMS 26 may be configured to control various energy sources and loads throughout residential building 28. For example, HEMS 26 may be configured to control energy from electric power grid 40, energy from vehicle and stationery batteries 38 and 46, energy from solar panels 50, and energy from wind turbines 54. HEMS 26 also may be configured to control energy usage by lighting, heating and air conditioning, pool and spa equipment, refrigerators, freezers, and other appliances throughout a residential building 28. For example, HEMS 26 may be configured to use energy from batteries 38 and 46, energy from solar panels 50, and energy from wind turbines 54 with a reduced or no reliance on energy from the electrical power grid 40 during periods of peak energy demand, high real time pricing (RTP) of energy, power outages, or low building demand at residential building 28. HEMS 26 may be configured to partially or entirely rely on energy from electric power grid 40 during periods of low energy demand, low real time pricing (RTP) of energy, low charge of batteries 38 and 46, and high building demand at residential building 28. HEMS 26 may be programmable with user preferences of energy conservation, comfort levels, energy needs, work schedules, travel schedules, and other factors to optimize the usage of the energy sources for loads within residential building 28.

HEMS 26, in an exemplary embodiment, may be configured to provide energy from residential building 28 and/or vehicle 36 back to electric power grid 40 based on various demand response signals 20. For example, if demand response signals 20 indicate a high demand or high real time pricing (RTP) of energy, then HEMS 26 may provide energy from batteries 38 and 46, energy from solar panels 50, and energy from wind turbines 54 back to electric power grid 40.

For example, HEMS 26 may be configured to enable buying and selling of energy between power utility 24, residential building 28, commercial building 32, and others. HEMS 26 may enable a user to select a buying point and a selling point for electrical energy, such that HEMS 26 may intelligently use available energy sources to minimize costs and reliance on electric power grid 40 at residential building 28. For example, HEMS 26 may intelligently charge and store energy in batteries 38 and 46 when the real time pricing (RTP) of energy falls to the selected buying point, whereas HEMS 26 may intelligently discharge an output power from batteries 38 and 46 into electric power grid 40 when the real time pricing (RTP) of energy rises to the selected selling point. HEMS 26 also may intelligently sell energy from solar panels 50 and wind turbines 54 back to electric power grid 40 when the real time pricing (RTP) of energy rises to the selected selling point.

In an exemplary embodiment, HEMS 26 may include load priorities for various appliances throughout residential building. HEMS 26 may include preset and user selectable load priorities in the event of high demand, high real time pricing (RTP) of energy, power outages, and user schedules. For example, the load priority may include a high priority for refrigerators, freezers, security systems, and other important equipment. In the event of high demand, high pricing, or power outages, HEMS 26 may use energy from batteries 38 and 46, solar panels 50, and wind turbines 54 to power the various equipment in the preset or user defined order of priority.

Referring generally to FIGS. 1A and 1C, an exemplary embodiment of BMS 30 may be configured to perform many similar functions as HEMS 26. For example, BMS 30 may be configured to control various energy sources and loads throughout commercial building 32. Energy sources may include electric power grid 40, batteries 38 in vehicles 36, stationary batteries 48 in commercial building 32, and solar panels 52 on commercial building 32. In an exemplary embodiment, BMS 30 exchanges electricity 56 and control signal 58 with charging stations 42 and vehicles 36 disposed in parking lot 44. For example, parking lot 44 may include tens, hundreds, and thousands of charging stations 42 and plugged-in vehicles 36 with batteries 38.

BMS 30 may be configured to charge and discharge batteries 38 in vehicles 36 depending on demand response signals 20, building energy demand, and other factors. In an exemplary embodiment, BMS 30 may control charging stations 42, vehicles 36, and batteries 38 to discharge and provide electricity back to commercial building 32 and/or electric power grid 40 during periods of high demand on power grid 40, high demand in commercial building 32, high real time pricing (RTP) of energy, power outages, or energy spikes in commercial building 32. For example, BMS 30 may normalize energy demand in commercial building 32 by acquiring energy from batteries 38 in vehicles 36. BMS 30 also may sell electrical energy from vehicles 36 in parking lot 44 to power utility 24 during periods of high demand on electric power grid 40 or high real time pricing (RTP) of energy. BMS 30 may control charging stations 42 to charge batteries 38 in vehicles 36 during periods of low demand on electric power grid 40, low real time pricing (RTP) of energy, low building demand at commercial building 32, or based on minimum charge levels for vehicles 36.

In exemplary embodiments, VCS 34 may include features similar to HEMS 26 and/or BMS 30. For example, VCS 34 may include vehicle controls, vehicle battery management controls, building controls, and other energy controls. The other energy controls may include power grid controls, solar panel controls, wind turbine controls, stationary battery controls, and demand response controls. VCS 34 may be capable of smart energy controls for integration into residential building 28 and/or commercial building 32 with or without HEMS 26 or BMS 30 present in such buildings.

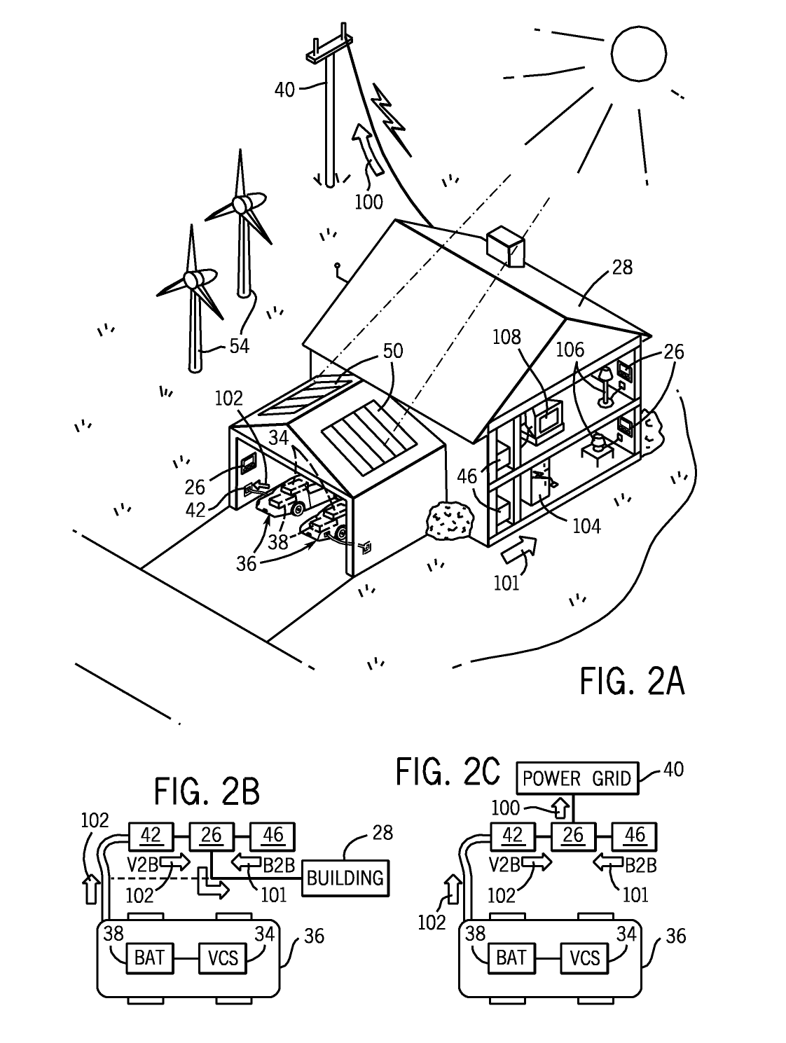

FIG. 2A is a schematic of an exemplary embodiment of residential building 28 having HEMS 26, showing an electrical demand response during a period of peak demand; (e.g., midday) on electrical power grid 40. In the exemplary embodiment, HEMS 26 may use local energy sources rather than power grid 40 to run lighting, appliances, and equipment throughout residential building 28 during the period of peak demand. For example, HEMS 26 may use energy from vehicle and stationary batteries 38 and 46, solar panels 50, and wind turbines 54 to power at least some or all loads throughout residential building 28. HEMS 26 may rely first on solar panels 50 and wind turbines 54, second on batteries 38 and 46, and third on power grid 40 during the period of peak demand. HEMS 26 may distribute these power sources to residential loads in an order of load priority, a reduced energy consumption configuration, or based on user preferences. For example, HEMS 26 may use a load priority to discharge vehicle and stationary batteries 38 and 46 to power only more important or critical equipment, such as freezers, refrigerators, and security systems. Depending on local needs and real time pricing (RTP) of energy, HEMS 26 may transfer energy from batteries 38 and 46, solar panels 50, and wind turbines 54 back to electrical power grid 40 during the period of peak demand.

In the exemplary embodiment, HEMS 26 may control charging and discharging of batteries 38 and 46 alone or in combination with VCS 34 in vehicle 36 and/or UEMS 22 at power utility 24. For example, in an exemplary embodiment, VCS 34 may override all or some of the energy management features of HEMS 26, or vice versa. For example, a homeowner at residential building 28 may synchronize each personal vehicle 36 with HEMS 26, such that HEMS 26 may completely control VCS 34 and battery 38 of such personal vehicle 36. However, third party vehicles 36 may not submit to complete control by HEMS 26, but rather each third party vehicle 36 may have energy control features to override HEMS 26. In an exemplary embodiment, HEMS 26 and/or VCS 34 may control vehicle battery 38 to discharge 100 back in to power grid 40, which may be described as vehicle to grid (V2G), and stationary battery 46 to discharge 100 back in to power grid 40, which may be described as building/battery to grid (B2G). Thus, battery discharge 100 may include V2G and/or B2G. HEMS 26 and/or VCS 34 may control stationary battery 46 to discharge 101 into residential building 28, which may be described as battery to building (B2B), and vehicle battery 38 to discharge 102 into residential building 28, which may be described as vehicle to building (V2B). Thus, battery discharge 101 and 102 may power residential building 28 rather than power grid 40. For example, discharges 101 and/or 102 back into residential building 28 may be configured to power critical appliances, such as a refrigerator/freezer 104. However, discharges 101 and/or 102 back into residential building 28 also may power other devices and equipment, such as lighting 106, televisions 108, heating and air conditioning, and security systems.

FIG. 2B is a block diagram of an exemplary embodiment of residential building 28 having both vehicle to building (V2B) 102 and battery to building (B2B) 101 electricity transfers. During periods of high demand and/or high real time pricing (RTP) of energy, stationary battery 46 may discharge (B2B) 101 into residential building 28 and vehicle battery 38 may discharge (V2B) 102 into residential building 28 to power various residential loads. During this period, HEMS 26 and VCS 34 may reduce or eliminate all reliance on power grid 40 until demand and/or pricing decreases to a relatively lower level. The electricity transfers 101 and 102 may be controlled by UEMS 22, HEMS 26, and/or VCS 34. For example, power utility 24 may or may not be involved in the controls that trigger the electricity transfers 101 and 102. In an exemplary embodiment, HEMS 26 or VCS 34 may trigger electricity transfers 101 and/or 102 completely independent of UEMS 22 and power utility 24. For example, HEMS 26 or VCS 34 may control electricity transfers 101 and/or 102 based on a time clock, residential building energy demands, a residential energy control scheme, or a control signal independent from power utility 24.

FIG. 2C is a block diagram of an exemplary embodiment of residential building 28 having vehicle to building (V2B) 102 and battery to building (B2B) 101 electricity transfers, and a building to grid (B2B) electricity transfer 100. In an exemplary embodiment, vehicle battery 38 may discharge (V2G) 100 back in to power grid 40 and stationary battery 46 may discharge (B2G) 100 back in to power grid 40. The electricity transfers 100, 101, and 102 may be controlled by UEMS 22, HEMS 26, and/or VCS 34. For example, power utility 24 may or may not be involved in the controls that trigger the electricity transfers 100, 101, and 102. In an exemplary embodiment, HEMS 26 or VCS 34 may trigger electricity transfers 100, 101, and/or 102 completely independent of UEMS 22 and power utility 24. For example, HEMS 26 or VCS 34 may control electricity transfers 100, 101, and 102 based on a time clock, residential building energy demands, a residential energy control scheme, residential demands in a local neighborhood, a residential control scheme in a local neighborhood, or a control signal independent from power utility 24.

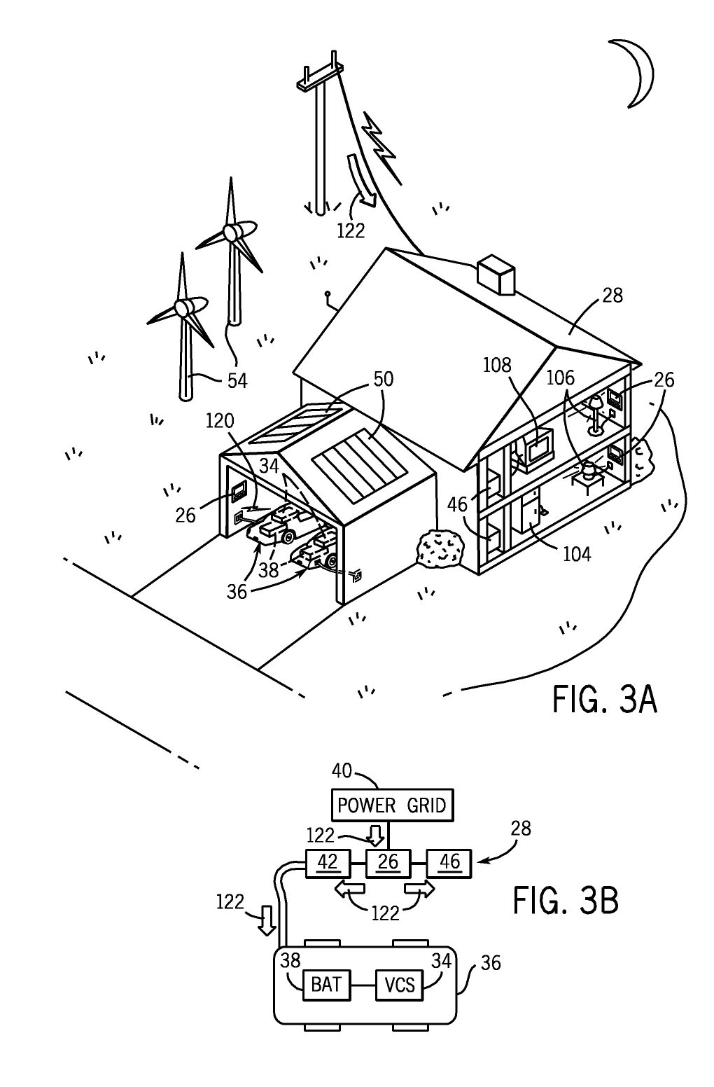

FIG. 3A is a schematic of an exemplary embodiment of residential building 28 having HEMS 26, showing an electrical demand response during a period of off peak demand (e.g., midnight) on electrical power grid 40. In the exemplary embodiment, HEMS 26 may control battery chargers to recharge 120 vehicle and stationary batteries 38 and 46 with power grid electricity 122 or the local power source (e.g., wind turbines 54 or solar panels 50). For example, HEMS 26 may receive demand response signals 20 indicating a low energy demand on power grid 40 or a low real time pricing (RTP) of energy for low cost battery charging of vehicle and stationary batteries 38 and 46. During this period, HEMS 26 may rely on power grid electricity 122 to power refrigerators/freezers 104, lighting 106, televisions 108, heating and air conditioning, pool/spa equipment, pumps, heaters, and other appliances using energy 122 from power grid 40 and wind turbines 54 without reliance on stored energy in batteries 38 and 46. HEMS 26 may control energy usage at residential building 28 alone or in combination with control features of VCS 34 and UEMS 22. For example, HEMS 26 may override VCS 34, or vice versa, depending on vehicle ownership, user preferences, demand response signals 20, and other factors.

FIG. 3B is a block diagram of an exemplary embodiment of residential building 28 having both power grid to vehicle (G2V) and power grid to battery (G2B) electricity transfers 122 for charging vehicle and stationary batteries 38 and 46. During periods of low demand and/or low real time pricing (RTP) of energy, power grid 40 may provide electricity transfers 122 to both vehicle battery 38 and stationary battery 46 via HEMS 26, vehicle charging station 42, and VCS 34. During this period, HEMS 26 and VCS 34 may reduce or eliminate all reliance on battery power from batteries 38 and 46 until demand and/or pricing increases to a relatively higher level. The electricity transfers 122 may be controlled by UEMS 22, HEMS 26, and/or VCS 34. For example, power utility 24 may or may not be involved in the controls that trigger the electricity transfers 122. In an exemplary embodiment, HEMS 26 or VCS 34 may trigger electricity transfers 122 completely independent of UEMS 22 and power utility 24. For example, HEMS 26 or VCS 34 may control electricity transfers 122 based on a time clock, residential building energy demands, a residential energy control scheme, or a control signal independent from power utility 24.

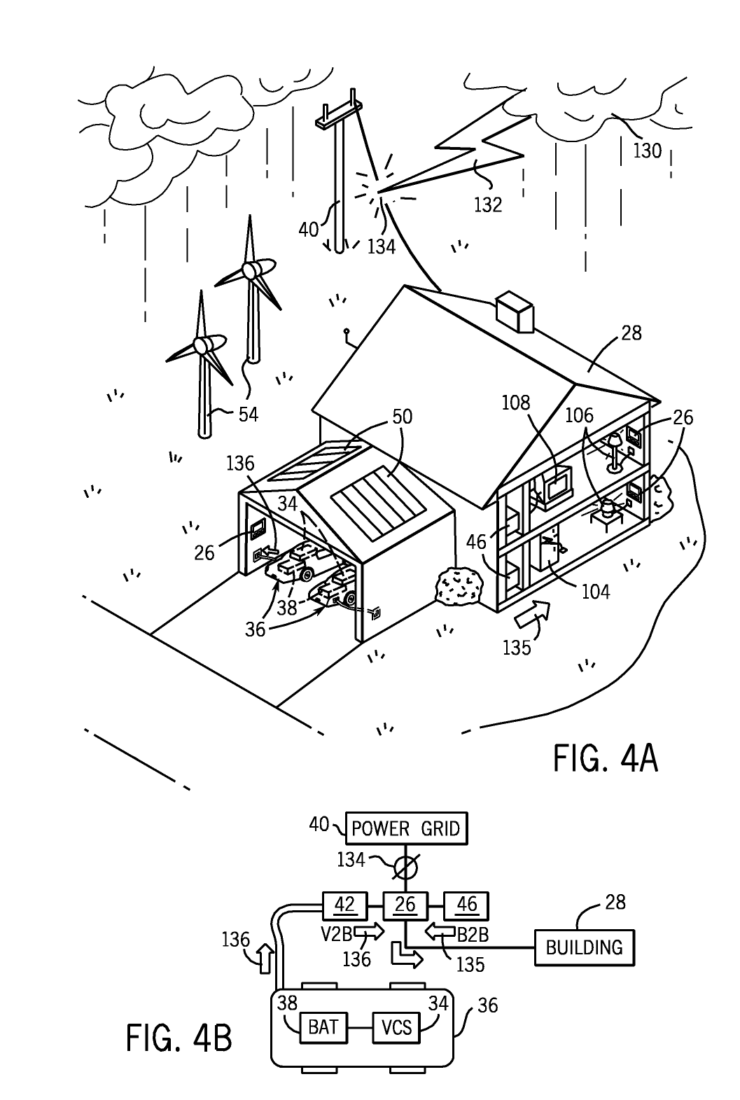

FIG. 4A is a schematic of an exemplary embodiment of residential building 28 having HEMS 26, showing an electrical demand response during a period of power outage (e.g., storm or natural disaster) from electrical power grid 40. In the exemplary embodiment, a storm 130 produces a lighting strike 132, which causes an interruption 134 in power grid 40 leading to residential building 28. As a result of interruption 134, HEMS 26 may distribute local power in an order of priority starting with solar panels 50 and wind turbines 54 as a first priority, stationary batteries 46 as a second priority, and vehicle battery 38 as a third priority. If solar panels 50 and wind turbines 54 provide sufficient power to residential building 28, then HEMS 26 may defer use of batteries 38 and 46 until power levels drop below the demands of loads throughout residential building 28. However, HEMS 26 may automatically turn to batteries 38 and/or 46 at the time of the interruption 134 and/or to fill gaps/dips in energy from solar panels 50 and wind turbines 54. As needed, HEMS 26 may be configured to rely on vehicle and stationary batteries 38 and 46 for backup power to refrigerators/freezers 104, lighting 106, televisions 108, heating and air conditioning, and other appliances throughout residential building 28. In an exemplary embodiment, batteries 38 and 46 may discharge to provide power 135 and 136 back to an electrical system of residential building 28 to power at least important loads in residential building 28. For example, HEMS 26 may obtain power from vehicle and stationary batteries 38 and 46 to power refrigerator/freezer 104 and at least some lighting 106.

In an exemplary embodiment, HEMS 26 may substantially or completely control energy management throughout residential building 28 and vehicle 36. However, in an exemplary embodiment, VCS 34 of vehicle 36 may override at least some or all control features of HEMS 26. For example, HEMS 26 may control backup power to one set of devices throughout residential building 28, whereas VCS 34 may control backup power to a different set of devices throughout residential building 28. HEMS 26 and VCS 34 also may provide different backup periods and minimum charge levels for vehicle battery 38. For example, HEMS 26 may enable a complete discharge of vehicle battery 38, whereas VCS 34 may enable only a partial discharge of vehicle battery 38. The interaction between HEMS 26 and VCS 34 may depend on ownership of residential building and vehicle 36 among other factors.

FIG. 4B is a block diagram of an exemplary embodiment of residential building 28 having both vehicle to building (V2B) 102 and battery to building (B2B) 101 electricity transfers during power interruption 134 from power grid 40. During periods of interruption 134, stationary battery 46 may discharge (B2B) 101 into residential building 28 and vehicle battery 38 may discharge (V2B) 102 into residential building 28 to power various residential loads. During this period, HEMS 26 and VCS 34 may monitor for a return of electricity to power grid 40, while intelligently controlling the distribution of battery power among residential loads. The electricity transfers 101 and 102 may be controlled by UEMS 22, HEMS 26, and/or VCS 34. For example, power utility 24 may or may not be involved in the controls that trigger the electricity transfers 101 and 102. In an exemplary embodiment, UEMS 22 may communicate data regarding power interruption 134, e.g., expected outage duration or expected return of power. UEMS 22 may use a wired or wireless network to communicate this data directly to HEMS 26 and/or VCS 34 to enable intelligent usage of battery power based on such data. In an exemplary embodiment, HEMS 26 or VCS 34 may trigger electricity transfers 101 and/or 102 completely independent of UEMS 22 and power utility 24. For example, HEMS 26 or VCS 34 may control electricity transfers 122 based on residential building energy demands, a residential energy control scheme, a power outage emergency control scheme, or a control signal independent from power utility 24.

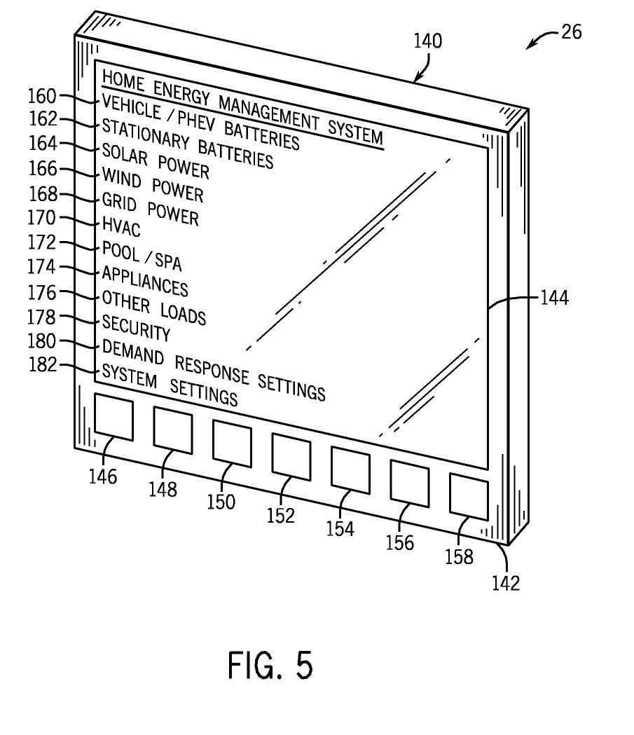

FIG. 5 is a schematic of an exemplary embodiment of a user interface 140 of HEMS 26. In an exemplary embodiment, user interface 140 may include a control panel 142 having a screen 144 and control buttons 146, 148, 150, 152, 154, 156, and 158. Screen 144 may include a liquid crystal display (LCD) or a touch screen display. Screen 144 may provide a menu of controllable features, such as vehicle/PHEV batteries 160, stationary batteries 162, solar power 164, wind power 166, grid power 168, HVAC 170, pool/spa 172, appliances 174, other loads 176, security 178, demand response settings 180, and system settings 182. In an exemplary embodiment, user interface 140 enables user control of both operational settings of building systems and energy settings of various energy sources. Control panel 142 may be a stand-alone panel, such as a wireless remote control, or an integrated wall-mount control panel. Control panel 142 may be configured for use solely in residential building 28, or control panel 142 may be portable and modular for use in vehicle 36 and commercial building 32. In exemplary embodiments, control panel 142 may include vehicle controls and commercial building controls.

Control selections 160 through 182 may enable user customized settings of equipment operational parameters and energy management. Referring first to control selections 160 through 168, energy management may include usage of available energy sources in response to grid power shortages, grid power real time pricing (RTP) of energy, user comfort levels, daily, monthly, or yearly electrical usage/cost, and other factors. For example, vehicle/PHEV battery selection 160 may enable control of charging and discharging of vehicle batteries 38 (FIG. 1B), assignment of loads to use energy from vehicle batteries, historical trends in charging and discharging of vehicle batteries, home settings for vehicle batteries, and away setting for vehicle batteries. Stationary batteries selection 162 may enable control of charging and discharging of stationary batteries 46 (FIG. 1B), assignment of loads to stationary batteries 46, and other control features similar to those of vehicle battery selection 160. Solar power selection 164 may enable user control of solar energy from solar panels 50 (FIG. 1A), assignment of loads to solar panels 50, viewing of historical energy generation and consumption of solar energy, and selling points for selling solar energy back to power grid 40. Wind power selection 166 may enable user control of wind energy from wind turbines 54 (FIG. 1A), assignment of loads to wind turbines 54, viewing of historical energy generation and usage of wind energy, and selling points for selling wind energy back to power grid 40. Grid power selection 168 may enable user control of energy usage from power grid 40 based on energy conservation preferences, comfort levels, real time pricing (RTP) of energy, critical loads, daily, monthly, and yearly usage/cost details, and other factors.

Control selections 170 through 178 relate to operational parameters for residential loads. HVAC selection 170 may enable user control of HVAC equipment based on comfort levels, real time pricing (RTP) of energy, availability of battery, solar, and wind power at residential building 28, and availability of grid power. Pool/spa selection 172, appliances selection 174, and other load selection 176 may enable user control of the various equipment throughout residential building 28 based on performance levels, energy conservation preferences, availability of grid power, availability of battery, solar, and wind power, and real time pricing (RTP) of energy. Security selection 178 may enable user control of a home security system, including door sensors, window sensors, and motion sensors.

Demand response settings 180 may enable user control of local energy usage in response to demand response signals 20 from power utility 24. For example, demand response settings 180 may include user comfort levels, buying and selling points for electricity, charging and discharging preferences for vehicle and stationary batteries 38 and 46, and other settings impacting the residential energy storage, vehicle energy storage, residential energy consumption, vehicle energy to power grid 40, and residential building 28 to power grid 40.

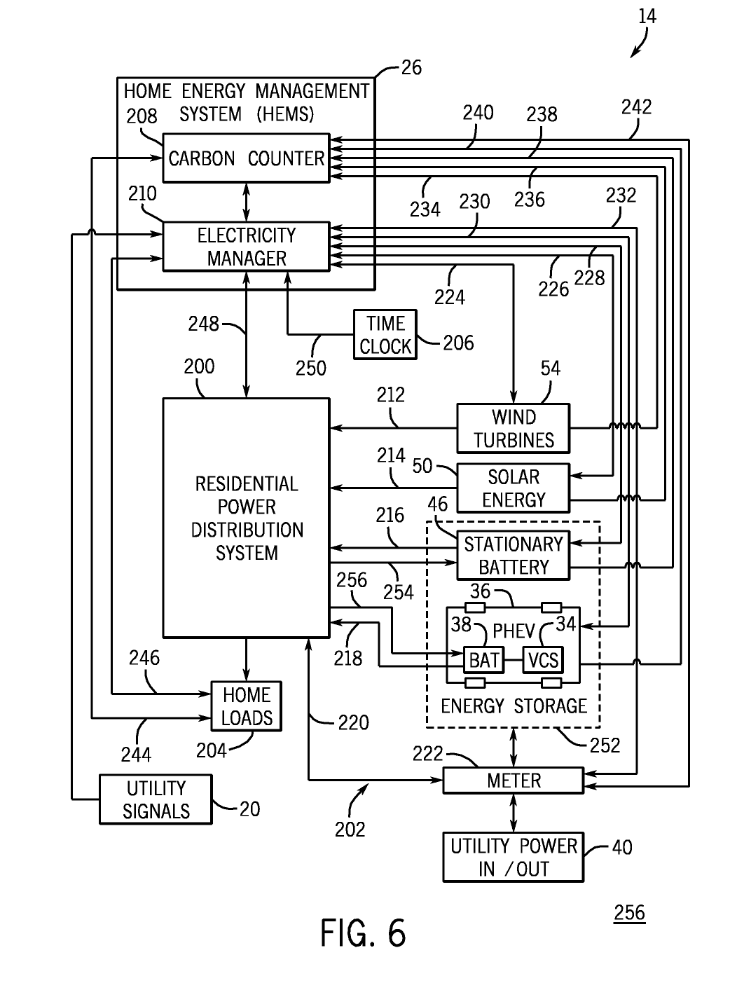

FIG. 6 is a block diagram of an exemplary embodiment of a residential electrical demand response system 14 having HEMS 26 of FIGS. 1 through 5. In an exemplary embodiment, HEMS 26 may be coupled to a residential power distribution system 200, energy sources 202, home loads 204, and a real time clock 206. HEMS 26 may include a carbon counter 208 and an electricity manager 210 configured to optimize usage of energy sources 202 among home loads 204 and/or power grid 40. For example, carbon counter 208 and electricity manager 210 may be configured to measure, control, and generally communicate with residential power distribution system 200, energy sources 202, home loads 204, time clock 206, and utility signals 20.

Residential power distribution system 200 may include residential wiring, circuit breakers, control circuitry, and power distribution panel disposed in residential building 28. In an exemplary embodiment, residential power distribution system 200 may receive wind energy 212 from wind turbines 54, solar energy 214 from solar panels 50, stationary battery power 216 from stationary battery 46, vehicle battery power 218 from battery 38 in vehicle 36, and grid power 220 from meter 222 coupled to power grid 40.

In an exemplary embodiment, each of the energy sources 202 may be communicative with carbon counter 208 and electricity manager 210 to reduce reliance on power grid 240, improve energy conservation, reduce greenhouse gas emissions (e.g., carbon) associated with power generation, and reduce costs associated with powering home loads 204. For example, HEMS 26 may exchange control signals and measurement data 224, 226, 228, 230, and 232 between electricity manager 210 and wind turbines 54, solar panels 50, stationary battery 46, vehicle 36, and meter 222, respectively. HEMS 26 also may exchange signals and data 234, 236, 238, 240, and 242 between carbon counter 208 and wind turbines 54, solar panels 50, stationary battery 46, vehicle 36, and meter 222, respectively to determine the amount of green house gases being generated and/or deferred. Signals and data 224 through 242 (as well as information from the Carbon Counter 208) are configured to enable HEMS 26 to intelligently control distribution of energy sources 202 through residential power distribution system 200 to various home loads 204. In an exemplary embodiment, HEMS 26 is configured to exchange signals and data 244 between carbon counter 208 and various home loads 204, and also signals and data 246 between electricity manager 210 and various home loads 204.

HEMS 26, in an exemplary embodiment, may be configured to monitor and control 248 residential power distribution 200 based on signals and data 224 through 242 exchanged with energy sources 202, time data 250 received from time clock 206, data and signals 244 and 246 exchanged with home loads 204, and utility signals 20 exchanged with power utility 24. For example, in an exemplary embodiment, electricity manager 210 may compare available energy 212 through 220 relative to home loads 204, time data 250, and utility signals 220 to intelligently use wind energy 212, solar energy 214, and battery energy 216 and 218 as a tradeoff with grid power 220. Electricity manager 210 may prioritize energy usage and distribution to home loads 204 based on real time pricing (RTP) of energy, power grid demand, grid generation fuel mix (carbon generation), residential building demand, user comfort levels, power grid outages, and various user preferences. In an exemplary embodiment, electricity manager 210 may control energy usage and distribution completely independent from power utility 24, e.g., based on a time clock, residential building energy demands, a residential energy control scheme, or a control signal independent from power utility 24.

Electricity manager 210, in an exemplary embodiment, may control 248 residential power distribution system 200 to use available wind energy 212 and solar energy 214 to power various home loads 204 as a first priority. If wind energy 212 and solar energy 214 is insufficient to power home loads 204, then electricity manager 210 may control 248 residential power distribution system 200 to either cut low priority home loads 204 or draw additional power from either energy storage 252 or electric power grid 40. For example, if electricity manager 210 receives signals 20 indicating a high power grid demand, high carbon content of generation sources, or high real time pricing (RTP) of energy, then electricity manager 210 may control 248 residential power distribution system 200 to use stationary battery power 216 to power various home loads 204 as a secondary priority. If stationary battery power 216 is insufficient to meet the demands of home loads 204, then electricity manager 210 may control 248 residential power distribution system 200 to use vehicle battery power 218 as a supplement to power home loads 204 as a third priority. If home loads 204 still demand additional power, then electricity manager 210 may control 248 residential power distribution system 200 to use grid power 220 to power home loads 204 as a forth priority. Electricity manager 210 also may cut at least some or all of the power to home loads 204 depending on utility signals 20, time data 250, and available energy sources 202. For example, electricity manager 210 may cut low priority home loads 204 during periods of high power grid demand, high real time pricing (RTP) of energy, power outages, or natural disasters.

If electricity manager 210 receives utility signals 20 indicating a low power grid demand or low real time pricing (RTP) of energy, then electricity manager 210 may control 248 residential power distribution system 200 to charge 254 stationary battery 46 and charge 256 vehicle battery 38 in vehicle 36. In this exemplary embodiment, electricity manager 210 may control 248 residential power distribution system 200 to use wind and solar energy 212 and 214 as a first priority, grid power 220 as a second priority, stationary battery power 216 as a third priority, and a vehicle battery power 218 and a fourth priority. In view of utility signals 20, electricity manager 210 may reduce reliance and costs associated with power grid 40 by storing low cost grid power 220 into energy storage 252 and using energy storage 252 during periods of high cost grid power 220. Energy storage 252 essentially shifts demand on power grid 40 from a period of high demand and high real time pricing (RTP) of energy to a later period of low demand and low real time pricing (RTP) of energy. For example, electricity manager 210 may control 248 residential power distribution system 200 to charge energy storage 252 at night, and discharge energy storage 252 to power home loads 204 during the day.

Electricity manager 210, in an exemplary embodiment, may be configured to even a building load and reduce peak demand. If energy demands of home loads 204 vary over a period of time (e.g., sudden spikes and dips), then electricity manager 210 may control 248 residential power distribution systems 200 to periodically charge and discharge batteries 46 and 38 to generally eliminate the spikes and dips on power grid 40. For example, electricity manager 210 may control 248 residential power distribution systems 200 to draw battery power 216 and 218 to reduce spikes to help normalize usage of grid power 220. Electricity manager 210 may control 248 residential power distribution systems 200 to charge 254 and 256 batteries 46 and 38 to reduce dips to help normalize usage of grid power 220.

In an exemplary embodiment, electricity manager 210 may be configured to control 248 residential power distribution system 200 to buy and sell energy sources 202 based on utility signals 20, e.g., demand levels and real time pricing (RTP) of energy. For example, if utility signals 20 indicate a high real time pricing (RTP) of energy, then electricity manager 210 may control 248 residential power distribution system 200 to sell wind energy 212, solar energy 214, stationary battery power 216, and/or vehicle battery power 218 back to power grid 40 through meter 222. If utility signals 20 indicate a low real time pricing (RTP) of energy, then electricity manager 210 may control 248 residential power distribution system 200 to use at least some grid power 220 to recharge 254 and 256 batteries 46 and 38.

In an exemplary embodiment, carbon counter 208 may be configured to monitor usage of energy sources 202 to evaluate the usage of clean power generation systems (e.g., wind, solar, water, etc.) versus relatively unclean power generation systems (e.g., coal). For example, carbon counter 208 may be configured to monitor clean power associated with wind turbines 54 and solar panels 50. Carbon counter 208 also may be configured to monitor usage of grid power 220 from unclean power utilities 24, such as coal plants or other carbon producing power generation facilities. For example, carbon counter 208 may measure kilowatts of wind and solar energy 212 and 214 versus coal generated grid power 220. In an exemplary embodiment, carbon counter 208 may record kilowatts of available wind and solar energy 212 and 214 to provide historical data, which may be used to facilitate selling of the wind/solar power back to power utility 24. The HEMS 26 may also be configured to try and use as much clean energy as possible independent of price.

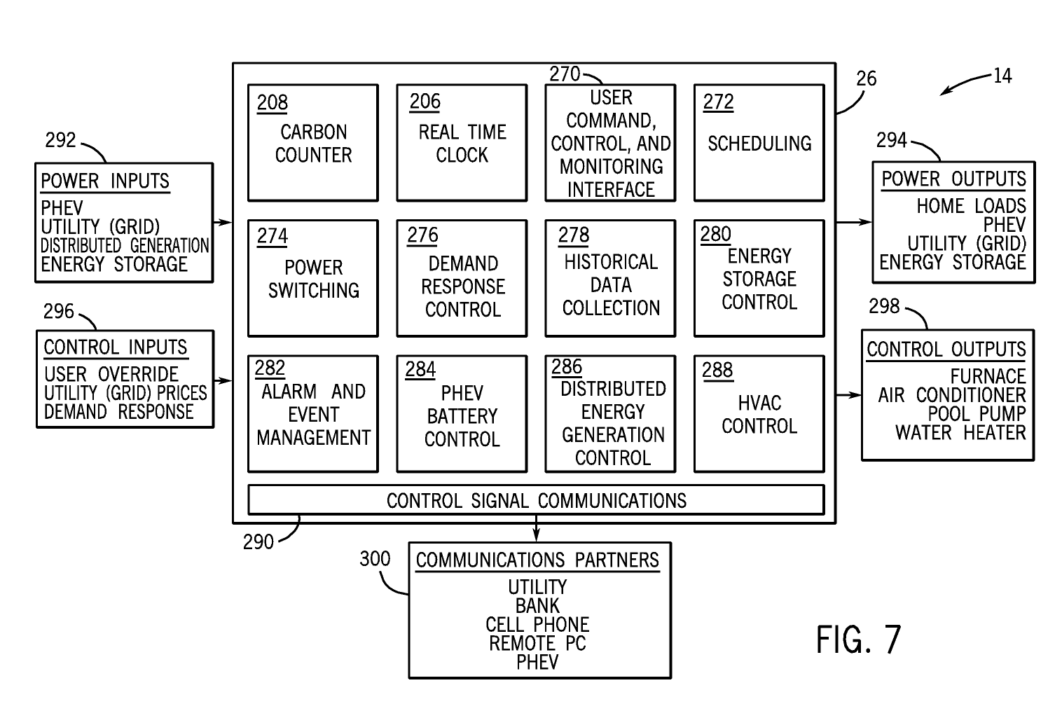

FIG. 7 is a block diagram of an exemplary embodiment of HEMS 26 of FIGS. 1 through 6. In an exemplary embodiment, HEMS 26 includes carbon counter 208, real time clock 206, user command, control, and monitoring interface 270, scheduling 272, power switching 274, demand response control 276, historical data collection 278, energy storage control 280, alarm and event management 282, PHEV battery control 284, distributed energy generation control 286, HVAC control 288, and control signal communications 290. HEMS 26 may receive power inputs 292 and provide power output 294, receive control inputs 296 and provide control outputs 298, and communicate with various communications partners 300.

Power inputs 292 may include vehicles 36 (e.g., PHEVs), power grid 40, distributed generation (e.g., solar panels 50 and wind turbines 54), and batteries 46 and 38. Power outputs 294 may include home loads, vehicles 36, power grid 40, and batteries 46 and 38. For example, home loads may include refrigerators, freezers, furnaces, air conditioners, pool/spa pumps, pool/spa heaters, water heaters, lighting, security, and various appliances. Control inputs 296 may include user overrides, real time pricing (RTP) from power grid 40, carbon content of generation from power grid 40, and demand response signals 20. Control outputs 298 may include refrigerators, freezers, furnaces, air conditioners, pool/spa pumps, pool/spa heaters, water heaters, lighting, security, and various appliances.

User command, control, and monitoring interface 270 may include a control panel, such as control panel 142 shown in FIG. 5, to enable user management of residential power distribution system 200, energy sources 202, and home loads 204 via inputs and outputs 292 through 298. Interface 270 may enable user management of controls 272 through 290. For example, interface 270 may enable user management of scheduling 272 to charge stationary and vehicle batteries 46 and 38 during periods of low demand while discharging batteries 46 and 38 into residential power distribution system 200 during periods of high demand. Interface 270 may enable user management of power switching 274 to selectively use one or more of energy sources 202 alone or in combination with one another for various home loads 204. For example, power switching 274 may enable automatic switching from grid power 220 to batteries 46 and 38 upon receiving control inputs 296 indicative of a high power grid demand, a high real time pricing (RTP) of energy, a power outage, or another event.

Interface 270 may enable user management of demand response control 276 to control energy sources 202 based on control inputs 296. For example, demand response control 276 may enable remote control by power utility 24, VCS 34 in vehicle 36, BMS 30 in commercial building 32, or another source. Demand response control 276 may enable user selection of various actions based on demand response control inputs 296. For example, demand response control 276 may enable a user to select an energy conservation mode or backup battery power mode in response to control inputs 296 indicative of high power grid demand or high real time pricing (RTP) of energy. In an exemplary embodiment, demand response control 276 may enable user management of buying and selling of electricity between residential building 28 and power utility 24. For example, demand response control 276 may enable user selection of selling prices for electricity, such that a user may sell wind energy 212, solar energy 214, and/or battery energy 216 and 218 to power utility 24 during periods of high demand or high real time pricing (RTP) of energy. Demand response control 276 also may enable user selection of a buying price for using grid power 220 to charge 254 and 256 batteries 46 and 38.

Historical data collection 278 may record energy usage and local power generation, such as power demands of home loads 204 and generated wind energy 212 and solar energy 214. Energy storage control 280 may be configured to control charging and discharging of stationary and vehicle batteries 46 and 38 in conjunction with scheduling 272, power switching 274, and demand response control 276. Alarm and event management 282 may be configured to alert a user of off-normal conditions (e.g. too hot or too cold in house), equipment failures, power outages, changes in energy demand, changes in real time pricing (RTP) of energy, levels of battery power in batteries 46 and 38, or various demand response signals from power utility 24.

PHEV battery control 284 may be configured to enable user management of charging and discharging of vehicle battery 38 depending on real time clock 206, scheduling 272, and user preferences. For example, PHEV battery control 284 may enable user customization based on work schedules, driving schedules, at home schedules, and other factors. Control 284 also may enable user selection of buying and selling prices for charging and discharging batteries 46 and 38 with power grid 40. Distributed energy generation control 286 may be configured to enable user management of wind turbines 54, solar panels 50, and other distributed energy sources. For example, control 286 may enable user selection of home loads 204 to use wind energy 212 and solar energy 214. Control 286 also may enable user selection of selling prices for selling wind energy 212 and solar energy 214 back to power utility 24. To modulate the amount of energy generated, distributed energy control 286 may control the angle of the solar panels 50 in reference to the sun or the pitch and speed of the wind turbine blades 54.

HVAC control 288 may enable user management of heating and cooling settings based on real time clock 206, scheduling 272, historical data collection 278, and control inputs 296. For example, HVAC control 288 may enable user selection of a comfort level and an energy conservation mode depending on real time pricing (RTP) of energy, occupancy of the residential building 28, and available energy sources 202.

In an exemplary embodiment, HEMS 26 may communicate with various communications partners, such as power utility 24, a bank, a cell phone, a remote computer, a PHEV, or another vehicle. For example, a user may remotely access and control HEMS 26 via a personal cell phone, computer, or vehicle. The bank may communicate with HEMS 26 for electricity billing based on automatic meter readings.

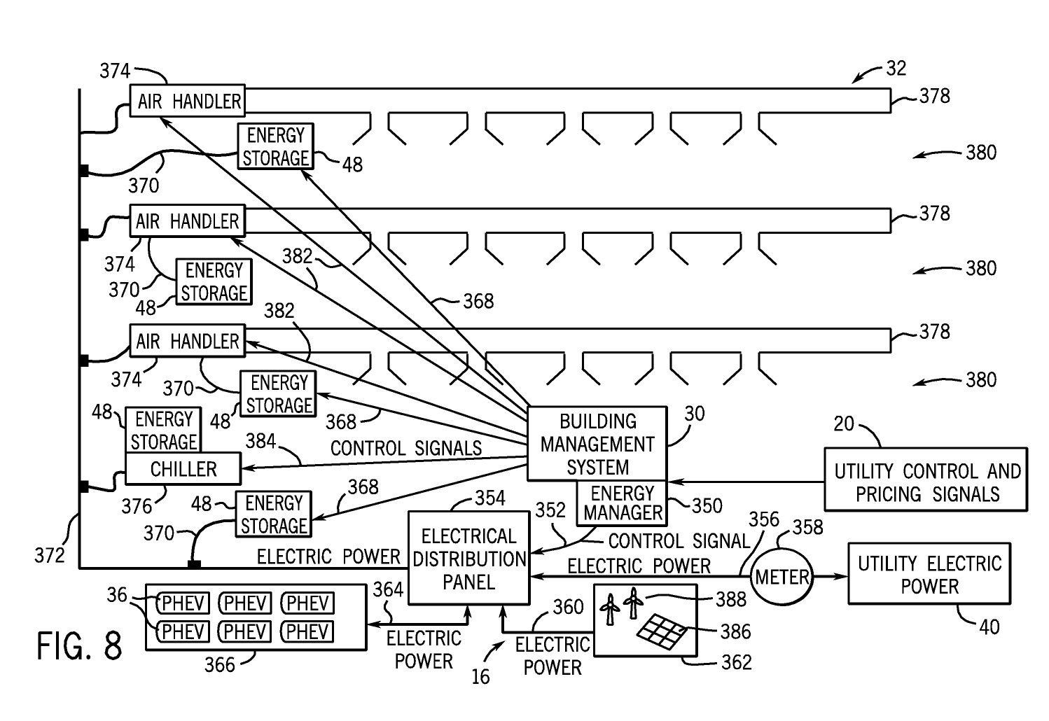

FIG. 8 is a block diagram of an exemplary embodiment of commercial demand response system 16 having BMS 30 of FIG. 1. In an exemplary embodiment, BMS 30 includes or communicates with an energy manager 350, which is configured to intelligently manage various energy sources throughout commercial building 32. For example, energy manager 350 may control 352 an electrical distribution panel 354 to distribute electric power 356 from a meter 358, electric power 360 from distributed energy sources 362, and electric power 364 from a fleet 366 of vehicles 36. BMS 30 also may use energy manager 350 to control 368 energy storage 48 to intelligently charge and discharge 370 into an electrical distribution system 372 within commercial building 32. For example, energy storage 48, such as stationary battery packs, may be distributed throughout commercial building 32 at various floors, rooms, and specific equipment. In an exemplary embodiment, energy storage 48 may be positioned at least close to or directly connected to various equipment, such as air handlers 374, chillers 376, security systems, computer systems, refrigerators/freezers, and equipment. For example, energy storage 48 may be provided for each air handler 374 coupled to a HVAC duct 378 on a respective floor 380 in commercial building 32. Energy storage 48 may be dedicated to specific equipment, such as air handlers 374 and chillers 376, or multiple commercial loads may receive power from energy storage 48. Energy storage 48 connected to air handlers 374, chillers 376, and various HVAC equipment may include a thermal storage system, which may reduce electrical energy consumption of the equipment by cool air with ice instead of mechanical cooling.

In an exemplary embodiment, BMS 30 along with energy manager 350 are configured to cooperatively manage both building systems and energy usage throughout commercial building 32. For example, BMS 30 may be configured to control 382 operation of air handlers 374, control 384 operation of chillers 376, control 368 charging and discharging 370 of energy storage 48, usage of electric power 356 from meter 358, usage of electric power 360 from distributed energy sources 362, usage of electric power 364 from fleet 366 of vehicles 36, and various other building systems and energy sources.

For example, BMS 30 and energy manager 350 may receive utility control and pricing signals 20 to trigger changes in the energy management throughout commercial building 32. In an exemplary embodiment, signals 20 may include a real time pricing (RTP) of energy signal, indicating a high or low price of electric power 356 received through meter 358 from electric power grid 40. In response to signals 20, BMS 30 and energy manager 350 may increase or decrease usage of electric power 356 from power grid 40 relative to electric power 360, 364, and 370 from distributed energy sources 362, fleet 366, and energy storage 48. For example, if signals 20 indicate a high real time pricing (RTP) of energy from power grid 40, then energy manager 350 may control energy distribution to use electric power 360 from distributed energy sources 362 as a first priority, electric power 370 from energy storage 48 as a second priority, electric power 364 from fleet 366 as a third priority, and electric power 356 from power grid 40 as a fourth priority. Distributed energy sources 362 may include solar panels 386 and wind turbines 388, which may provide a variable amount of electric power 360 depending on levels of sunlight and wind. If energy manager 350 determines that distributed energy sources 362 provide insufficient electric power 360 for commercial building 32, then energy manager 350 may turn to energy storage 48 and fleet 366 before relying on electric power 356 from power grid 40. If signals 20 are indicative of a low real time pricing (RTP) of energy from power grid 40, then energy manager 350 may use electric power 356 from power grid 40 rather than electric power 370 from energy storage 48 and electric power 364 from fleet 366. For example, in the event of a low real time pricing (RTP) of energy, energy manager 350 may use electric power 360 from distributed energy sources 362 as a first priority and electric power 356 from power grid 30 as a second priority. Energy manager 350 also may charge energy storage 48 and vehicles 36 in fleet 366 during periods of low demand and low real time pricing (RTP) of energy from power grid 40.

In an exemplary embodiment, BMS 30 and energy manager 350 may rely on energy storage 48 and fleet 356 to even a building load and reduce peak demand by commercial building 32 on power grid 40. For example, if equipment throughout commercial building 32 creates spikes in power demand, then energy storage 48 and vehicles 366 may discharge into electrical distribution system 372 to meet the spikes in demand. As a result, electrical demand on power grid 40 is generally constant due to the discharge of battery power into electrical distribution system 372. In an exemplary embodiment, BMS 30 and energy manager 350 may be configured to discharge battery power from energy storage 48 and fleet 366 into electrical distribution system 372 during periods of peak demand, e.g., midday when demand on power utility 24 is the greatest. During periods of low demand or sudden drops in electrical demand by commercial building 32, BMS 30 and energy manager 350 may be configured to charge batteries in energy storage 48 and fleet 366. As a result, the charging of batteries may even the electrical load by commercial building 32 on power grid 40.

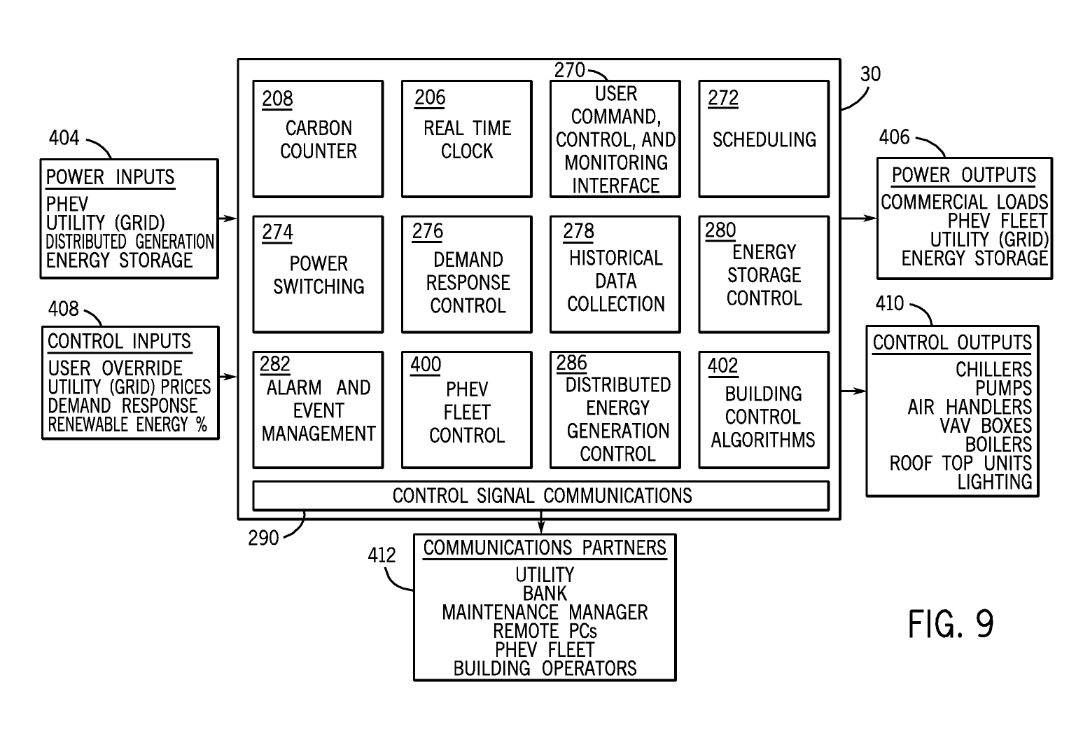

FIG. 9 is a block diagram of an exemplary embodiment of BMS 30 of FIGS. 1 and 8. In an exemplary embodiment, BMS 30 may have a variety of features similar to HEMS 26 as shown in FIG. 7. For example, BMS 30 may include carbon counter 208, real time clock 206, user command, control, and monitoring interface 270, scheduling 272, power switching 274, demand response control 276, historical data collection 278, energy storage control 280, alarm and event management 282, distributed energy generation control 286, and control signal communications 290. Rather than PHEV battery control 284 and HVAC control 288 of HEMS 26, BMS 30 may include PHEV fleet control 400 and building control algorithms 402.

BMS 30 may receive power inputs 404 and provide power outputs 406, receive control inputs 408 and provide control outputs 410, and communicate with various communication partners 412. In an exemplary embodiment, power inputs 404 may include a PHEV fleet, a power utility grid, distributed power generation, and energy storage. Power outputs 406 may include commercial loads, PHEV fleet, utility power grid, and energy storage. Control inputs 408 may include a user override, utility power grid prices, demand response signals, and renewable energy percentages. Control outputs 410 may include chillers, pumps, air handlers, VAV boxes, boilers, rooftop units, and lighting. Communication partners 412 may include a power utility, a bank, a maintenance manager, remote computers, PHEV fleet, and building operators.

In an exemplary embodiment, interface 270 may enable user management of PHEV fleet control 400 along with scheduling 272, power switching 274, demand response control 276, and other aspects of BMS 30. For example, PHEV fleet control 400 may enable user management of vehicle battery charging and discharging relative to commercial building 32. For example, if control inputs 408 indicate a high real time pricing (RTP) of energy from power grid 40, then the PHEV fleet control 400 may enable discharging of vehicle batteries 38 into electrical distribution system 372 of commercial building 32. If control inputs 408 indicate a low real time pricing (RTP) of energy from power grid 40, then PHEV fleet control 400 may enable battery charging of vehicle batteries 38 within the fleet.

Building control algorithms 402 may include operational controls of chillers, pumps, air handlers, VAV boxes, boilers, rooftop units, and lighting throughout commercial building 32. Building control algorithms 402 may be configured to adjust control outputs 410 based on available power inputs 404 and control signals 408. For example, building control algorithms 402 may shut down, turn on, or vary operation of building equipment based on available power inputs 404, projected air pollution, and real time pricing (RTP) of energy in control inputs 408. BMS 30 may be remotely controlled through one or more communication partners 412 via wireless or wired communications. For example, remote computers may communicate through the internet to enable user adjustment of building controls and energy usage via BMS 30.

With reference to FIGS. 1 through 7, the energy demand response system enables the energy storage and generation capabilities of vehicles (e.g., PHEVs) to be used to provide emergency back-up power for residential buildings or supply power back to the electric grid when needed. A PHEV may supply back up power for a residence for hours on battery storage alone or for days with combined battery storage and generation from the internal combustion engine. In a residential application, the garage may become the integration point for the demand response functionality. The PHEV may be charged by connection to an Energy Manager Unit (EM), which controls the power functions between the PHEV, the residence or other building, and the power grid. The EM may include a real-time clock to automate battery charging during off-peak hours. Two-way communication between the EM and the Vehicle Power Management System (VPMS) or Vehicle Control System (VCS) allows the current vehicle charge capacity to be used in making energy charging and discharging decisions.

In one mode of demand response, a utility provider, independent system operator (ISO) or Curtailment Service Provider (CSP) may provide a curtailment signal to the EM through Internet, wired broadband, wireless communications, or any other mode of communication. The EM then checks the storage capacity of the PHEV and, if sufficient, starts discharge of the battery until the storage capacity reaches a pre-determined minimum level (e.g., 40%) or the curtailment request is withdrawn. The EM directs the withdrawn electric power to the power grid. In an alternative mode, the utility provider, ISO or CSP sends electricity pricing information to the EM and then the EM decides if it is attractive to use the stored PHEV battery energy for supplying electrical power to the residence based on storage capacity of battery, time of day and economic incentives. The pricing information may be provided by the utility, ISO or CSP for one hour intervals and one day in advance. If stored energy is used, the PHEV energy is then either distributed to the home directly using a transfer switch or may be put back on the power grid. The former may allow a number of additional demand response options such as temporarily turning off optional or high requirement electrical loads such as air conditioning units, pool/spa pumps, etc. The latter may involve additional safety-related isolation components and net metering to “credit” the homeowner for the generated electricity.

Two-way communication capability with the EM may give utility provider, ISO or CSP direct grid regulation capability, verification of curtailment and real-time monitoring of storage capacity across the electrical grid, including PHEVs. However, a fully functional solution may be developed without two-way communication by providing pricing and/or curtailment signals to the EM and letting the EM take autonomous action driven by utility and/or ISO incentives.

With reference to FIGS. 1, 8, and 9, a commercial building may have a high quantity of vehicles in a parking structure or lot, such that PHEVs may be charged at designated parking spots. In a commercial situation, the electrical infrastructure and the EM may be designed to handle the larger number of PHEVs and the larger power system for the building. Unlike the residential situation in which the PHEVs may charge overnight, in the commercial application of the energy demand system, the PHEVs may charge in the early hours of the day and be used to supply energy to the building's power system at critical times in the afternoon when the demand reduction is most needed since commercial off-peak electricity rates are often lower than residential rates. During periods of high electrical demand, commercial building owners would find it cost effective to “top off” their employee's PHEVs in the morning in order to use a portion of the energy in the afternoon to reduce the building's peak demand. Commercial buildings may receive financial incentives from utilities for curtailing loads and bringing distributed generation online and have experienced staff and sophisticated systems for managing energy.

The current system may be integrated into such systems such as a system employing hard wired or radio frequency devices described in more detail below in order to provide a unified building management system. In exemplary embodiments, buildings 28 and 32 may include RF-enabled devices throughout any number of floors, rooms, spaces, zones, and/or other building structures. RF-enabled devices may exist inside or outside the building, on walls or on desks, be user interactive or not, and may be any type of building management device. For example, RF-enabled devices may include a security device, a light switch, a fan actuator, a temperature sensor, a thermostat, a smoke detector, etc. PHEVs, battery management systems, vehicle power management systems, and Energy Managers may include RF-enabled devices. System 10 may include a Human Machine Interface that operates as a communication device such as an RF-enabled device with the Energy Manager. RF-enabled devices may be configured to conduct building management functions (e.g., sense temperature, sense humidity, control a building management device, etc.). RF-enabled devices may also serve any number of network functions (e.g., RF measuring functions, network routing functions, etc.).

In an exemplary embodiment, a building management system (“BMS”) may include one or more network automation engines (“NAE”) connected to a proprietary or standard communications network such as an IP network (e.g., Ethernet, WiFi, ZigBee, Bluetooth, etc.). NAE may support various field-level communications protocols and/or technology, including various Internet Protocols (IP), BACnet over IP, BACnet Master-Slave/Token-Passing (MS/TP), N2 Bus, N2 over Ethernet, Wireless N2, LonWorks, ZigBee®, and any number of other standard or proprietary field-level building management protocols and/or technologies. NAE may include varying levels of supervisory features and building management. The user interface of NAE may be accessed via a web browser capable of communicably connecting to and accessing NAE. For example, multiple web browser terminals may variously connect to NAE or other devices of BMS. For example, a web browser may access BMS and connected NAEs via a WAN, local IP network, or via a connected wireless access point. A terminal may also access BMS and connected NAEs and provide information to another source, such as a printer.

NAE may have any number of BMS devices variously connected to it. These devices may include, among other devices not mentioned here, devices such as: field-level control modules, Variable Air Volume Modular Assemblies (VMAs), integrator units, variable air volume devices, extended digital controllers, unitary devices, air handling unit controllers, boilers, fan coil units, heat pump units, unit ventilators, Variable Air Volume (VAV) units, expansion modules, blowers, temperature sensors, flow transducers, sensors, motion detectors, actuators, dampers, air handling units, heaters, air conditioning units, etc. These devices may be controlled and/or monitored by NAE. Data generated by or available on the various devices that are directly or indirectly connected to NAE may be passed, sent, requested, or read by NAE. This data may be stored by NAE, processed by NAE, transformed by NAE, and/or sent to various other systems or terminals of the building management system. The various devices of the BMS may be connected to NAE with a wired connection or with a wireless connection. Depending on the configuration of the system 10, components such as the Energy Manager may function as an NAE or may also function as a BMS device connected to an NAE.

In an exemplary embodiment, system 10 may include a mesh network. Mesh network may include a building/parking area, a plurality of RF-enabled devices, a controller system, a network, and a workstation (e.g., a desktop computer, a personal digital assistant, a laptop, etc.). RF-enabled devices may be interconnected by RF connections. RF connections may be disabled (or otherwise unavailable) for various reasons. As a result, some RF-enabled devices may temporarily be disconnected from the mesh network, but are configured to automatically connect (or reconnect) to any other suitable device within range. Controller system may be connected to workstation via network. According to exemplary embodiments, RF-enabled devices may be arranged in another type of network topology.

Using a plurality of low-power and multi-function or reduced function wireless devices distributed around a building/parking area and configured in a mesh network in conjunction with the electrical demand response system 10, a redundant, agile, and cost-effective communications/energy system for building management systems may be provided to improve energy management.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A system, comprising:
a building control system, comprising:
a vehicle battery controller configured to control a vehicle battery charge and/or a vehicle battery discharge of a vehicle having a vehicle battery coupled to an electrical system of a building.

2. The system of claim 1, wherein the vehicle battery controller comprises a fleet control configured to control charging and discharging of a fleet of vehicles having vehicle batteries coupled to the electrical system of the building.

3. The system of claim 1, wherein the vehicle battery controller is configured to enable the vehicle battery charge during a first period of low demand on a power utility and enable the vehicle battery discharge during a second period of high demand on the power utility.

4. The system of claim 1, wherein the vehicle battery controller is configured to enable the vehicle battery discharge to provide battery power to the electrical system of the building during a power shortage or a power outage.

5. The system of claim 1, wherein the vehicle battery controller is configured to enable the vehicle battery discharge in response to a spike in electrical demand in the building, or enable the vehicle battery charge in response to a dip in electrical demand in the building, or a combination thereof.

6. The system of claim 1, wherein the vehicle battery controller is configured to control the vehicle battery charge and/or the vehicle battery discharge based on building energy demand, a building energy control scheme, or a control signal independent of a power utility.

7. The system of claim 1, wherein the building control system comprises an electricity buying/selling feature based on real time pricing of electricity.

8. The system of claim 1, wherein the building control system comprises a carbon counter configured to provide an indication of carbon generated or deferred by the building to facilitate selection of energy sources for use by the building control system.

9. The system of claim 1, wherein the building control system comprises a stationary battery controller configured to control a stationary battery charge and a stationary battery discharge of a stationary battery coupled to the electrical system of the building.

10. The system of claim 1, wherein the building control system comprises a distributed energy controller configured to control a distributed energy source coupled to the electrical system of the building.

11. The system of claim 1, wherein the distributed energy source comprises a wind turbine, a solar panel, momentum, thermal, hydro or a combination thereof.

12. The system of claim 1, wherein the building control system comprises an air conditioner control, a furnace control, a water heater control, a pool pump control, a lighting control, a refrigerator control, a freezer control, a security system control, an air handler control, a chiller control, a pump control, a boiler control, or a combination thereof.

13. A system, comprising:
a building control system, comprising:
an energy controller configured to vary usage of grid power from a power utility and battery power from a battery in response to real time pricing of grid power.

14. The system of claim 13, wherein the energy controller comprises a vehicle battery controller configured to control a vehicle battery charge and a vehicle battery discharge of a vehicle in response to the real time pricing of grid power.

15. The system of claim 13, wherein the energy controller comprises an electricity buying/selling feature based on the real time pricing of grid power.

16. The system of claim 13, wherein the energy controller comprises a vehicle battery controller, a stationary battery controller, a wind power controller, a solar power controller, and a power grid controller.

17. The system of claim 13, wherein the energy controller comprises a building load controller configured to control lighting, heating, air conditioning, and security in the building in response to real time pricing of grid power.

18. A system, comprising:
a control panel, comprising:
a demand response controller configured to receive a demand response control signal from a power utility; and
a vehicle battery controller configured to control a vehicle battery charge and a vehicle battery discharge of a vehicle having a vehicle battery based on the demand response control signal from the power utility.

19. The system of claim 18, wherein the vehicle battery controller is configured to enable the vehicle battery charge during a first period of low demand on a power utility and enable the vehicle battery discharge during a second period of high demand on the power utility.

20. The system of claim 18, wherein the control panel comprises a home energy mangement system, a building management system, a vehicle control system, or a combination thereof.
